(19) United States
(12) Patent Application Publication
(10) Pub. No.: US 2003/0096590 A1
(43) Pub. Date: May 22, 2003

(54) Interconnecting device

(76) Inventor: Kazuhiko Satoh, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/093,358

(22) Filed: Mar. 7, 2002

(30) Foreign Application Priority Data
Nov. 21, 2001 (JP) 2001-355424

(51) Int. Cl. H04M 1/00

(52) U.S. Cl. 455/404; 455/426; 455/556

(57) ABSTRACT

Various kinds of sensors 5-1 to 5-n are disposed inside a house of an aged person. When a value of a detection subject of each of the sensors 5-1 to 5-n exceeds a predetermined threshold value set respectively for a predetermined length of time, a sensor controlling section 3, judging this state to be an occurrence of abnormality, generates an abnormality notification signal including a number for identifying the aged person and the like, and including a kind of the abnormality such as gas leakage, overheating, or the like, and the abnormality notification signal is sent to a notification destination, which is registered in advance, by an interconnecting device 4 via a public telephone line 11, and when the abnormality notification signal is received by a receiving section 2, display by a display device 12a and so on are executed. Thereby, an occurrence of abnormality inside the house of the aged person can be found without delay and an appropriate countermeasure can be taken.

### BACKGROUND OF THE INVENTION

1. Field of the Invention

The present invention relates to a system which enables information on an abnormality occurrence inside houses of aged people to be notified to the outside, and more particularly to a system which can realize improvement in quickness and reliability and so on.

2. Description of the Related Art

All over the world has seen a gradual increase in a ratio of, what is called, an elderly population to the total population, this elderly population ratio exceeding a ratio of those except aged people to the total population, and this has presented indication that a so-called aging society is actually coming at hand year by year.

In view of this social situation, various kinds of services for supporting the lives of aged people have recently been practiced on various levels, such as on a governmental level, a non-governmental level, and so on.

Specifically, a so-called visiting service is one of the examples. In this service, patrolling staff regularly visit aged people who live alone to give advice to them on their worries and inconveniences and to make sure that nothing is wrong with the lives of the aged people.

However, it is often difficult to secure a sufficient number of patrolling staff members in the services like the above due to various reasons. Moreover, while this shortage of the staff is a general tendency, the number of aged people requiring these services is on the increase. Under these conditions, it is difficult to provide sufficient services to them.

There also exists a problem that consideration should be fully given to privacy protection of aged people in view of the basic nature of the visiting services mentioned above that the patrolling staff actually visit the houses of the aged people.

Furthermore, especially, in a case of aged people who live alone, there also exists a problem that it is impossible to quickly and surely discover accidents such as a fire due to increase in temperature and catching fire and gas poisoning which are caused because gas appliances are left turned on, an occurrence of a fire due to the use of a heater, and in winter, an occurrence of apoplexy and so on due to blood vessel contraction which is caused, for example, when they move from a warm living room to a cold washroom, and when they move from a warm bathroom to the outside of the bathroom where the temperature is relatively low, since in many cases of these visiting services described above, the patrolling staff member is seldom on the spot of these accidents.

### SUMMARY OF THE INVENTION

It is an object of the present invention to provide a supporting system for aged people using an interconnecting device and a supporting device for aged people which are able to support aged people in spending smooth lives while securing their privacy.

It is another object of the present invention to provide a supporting system for aged people using an interconnecting device and a supporting device for aged people which enable abnormality of aged people to be found quickly and surely with required manpower being reduced to the minimum and which enable an appropriate countermeasure to be taken.

According to a first aspect of the present invention, provided is

a supporting system for aged people using an interconnecting device, comprising:

a plurality of sensors for detecting abnormality inside a house of an aged person;

a sensor controlling section for outputting an abnormality notification signal based on output signals of the plural sensors;

an interconnecting device for interconnecting an output signal of the sensor controlling section to a receiving section; and

the receiving section for performing warning processing when the abnormality notification signal from the sensor controlling section is received.

In the configuration as described above, abnormality inside a house of an aged person is detected by the plural sensors and this information is transmitted via the interconnecting device to a proper place where the receiving section is provided so that the abnormality inside the house of the aged person can be detected quickly and surely outside the house without requiring manpower, which enables an appropriate countermeasure to be taken.

Furthermore, according to a second aspect of the present invention, provided is

a supporting device for aged people which is structured to detect abnormality inside a house of an aged person and to transmit an abnormality notification signal to a predetermined external place.

As a more preferable embodiment of this invention, provided is

a supporting device for aged people, comprising:

a plurality of sensors for detecting abnormality inside a house of an aged person;

a sensor controlling section for outputting an abnormality notification signal based on output signals of the plural sensors; and

an interconnecting device for interconnecting an output signal of the sensor controlling section to a predetermined external place.

### BRIEF DESCRIPTION OF THE DRAWINGS

FIG. 1 is a block diagram showing a first configuration example of a supporting system for aged people using an interconnecting device in an embodiment of the present invention;

FIG. 2 is an explanatory view explaining the disposition of sensors in the supporting system for aged people using an interconnecting device in the embodiment of the present invention;

FIG. 3 is a subroutine flow chart showing a procedure for operation control of a sensor controlling section in the supporting system for aged people using an interconnecting device in the embodiment of the present invention;

FIG. 4 is a block diagram showing a second configuration example of the supporting system for aged people using an interconnecting device in the embodiment of the present invention; and

FIG. 5 is a block diagram showing a third configuration example of the supporting system for aged people using an interconnecting device in the embodiment of the present invention.

### DETAILED DESCRIPTION OF THE PREFERRED EMBODIMENTS

The present invention will be hereinafter described in detail with reference to the drawings.

Incidentally, it is to be understood that the present invention is not intended to be limited to members, dispositions, and so forth which will be described below, and various modifications and improvements may be made therein without departing from the spirit of the present invention.

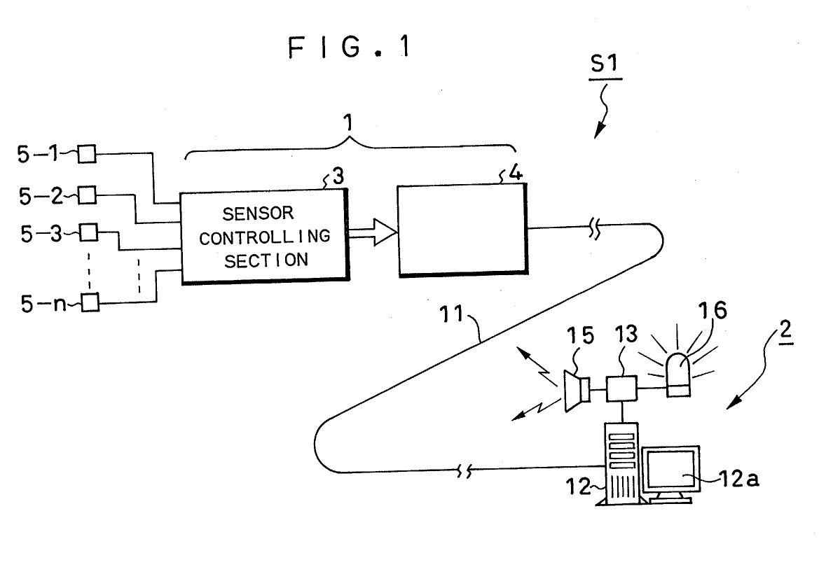

First, a first configuration example of a supporting system for aged people using an interconnecting device in an embodiment of the present invention is explained with reference to FIG. 1 to FIG. 3.

A supporting system S1 for aged people using an interconnecting device in the embodiment of the present invention is roughly divided into a supporting device 1 for aged people and a receiving section 2 (refer to FIG. 1).

The supporting device 1 for aged people is structured by a sensor controlling section 3 and an interconnecting device 4 as its main components, which are basically provided in a house of an aged person.

Meanwhile, the receiving section 2 is provided in appropriate places of a governmental organization, a non-governmental organization, and so on supporting aged people's lives (for example, a section in charge in a city, town, or village office, a firehouse, a police station, a neighboring house, and so on).

The sensor controlling section 3 has output signals of a plurality of sensors 5-1 to 5-n disposed inside the house of the aged person inputted thereto and performs necessary processing for transmitting these signals to the receiving section 2 via the interconnecting device 4 (to be detailed later).

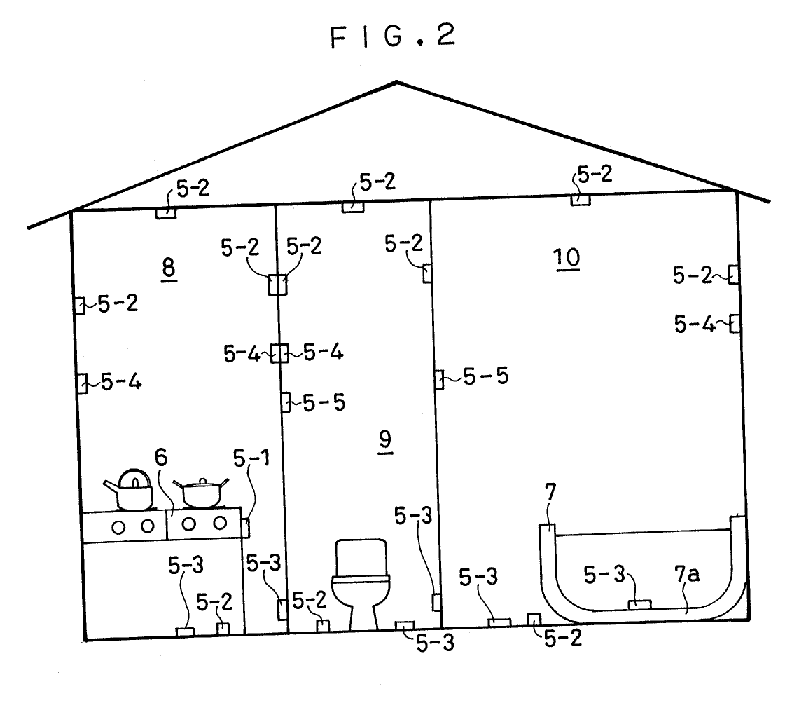

The plural sensors 5-1 to 5-n connected to the sensor controlling section 3 are specifically explained here with reference to FIG. 2. A gas sensor 5-1 in FIG. 2, which shows a disposition example of the plural sensors 5-1 to 5-n inside the house of the aged person, is first disposed in an appropriate place near a gas appliance 6. It should be understood that the gas sensor 5-1 needs to be installed in an appropriate place according to kinds of gas since gas is roughly divided into a so-called municipal gas and LP gas, each of which has a different weight, and depending on different weight of each kind of gas, a specialized gas sensor should be used and the gas sensor should be installed in an appropriate place. Therefore, FIG. 2 only shows that the gas sensor 5-1 is disposed around the gas appliance 6, and is not intended to specifically determine a place where the gas sensor 5-1 should be installed.

Furthermore, the number of the gas sensor 5-1 to be installed is not necessarily limited to one, and it may be disposed in plurality to improve detection reliability.

Temperature sensors 5-2 are disposed at a plurality of appropriate places in each room, for example, on a floor, a ceiling, and a wall. Incidentally, when they are disposed on the floor, it is preferable to dispose them appropriately on an upper surface or a lower surface of the floor according to a place where they are disposed.

The temperature sensors 5-2 are disposed in order to detect temperature increase due to catching fire, overheating, and the like, for example, of a heating appliance (not shown) such as a heater, the gas appliance 6, and the like.

Moreover, shock sensors 5-3 are disposed at a plurality of places on a floor and a wall, for example, in a living room (not shown), a kitchen 8, a washroom 9, a bathroom 10, and so on, and in addition, on a bottom surface 7a and so on of a bathtub 7 in order to detect an accident that the aged person faints due to some reason.

In addition, a plurality of smoke sensors 5-4 are disposed in appropriate places inside the rooms in order to detect an abnormality occurrence of smoke.

In/out detecting sensors 5-5 for detecting that the aged person gets in/out are also attached at an entrance of the washroom 9 and an entrance of the bathroom 10, more specifically, for example, on respective doors (not shown). Therefore, each of the sensors 5-5 detects that the aged person gets into the washroom 9 or the bathroom 10, and thereafter, gets out of the washroom 9 or the bathroom 10. Moreover, each of the sensors 5-5 outputs a predetermined signal when the aged person does not get out of the washroom 9 or the bathroom 10, in other words, when it is not detected that he/she gets out of the washroom 9 or the bathroom 10 even after a predetermined length of time passes after it is detected that the aged person gets in the washroom 9 or the bathroom 10.

The appropriate number of various sensors suitable for detecting some abnormality of the aged person are disposed in appropriate places in addition to the above-described sensors.

It is preferable that these plural sensors 5-1 to 5-n have structures so as to be installed easily not only by an aged person himself/herself but also by a volunteer. For example, sensors whose installing work can be finished only by sticking them on desired places after peeling off seals covering sticking surfaces over which substance such as adhesive is pasted in advance, sensors integrally structured with fixing members which can be fitted into appropriate spaces, and the like are preferable.

Moreover, all of the plural sensors 5-1 to 5-n are structured to be able to freely set detection levels, that is, threshold values, and timer time. In other words, the plural sensors 5-1 to 5-n are structured to output abnormality detection signals when temperature and so on of detection subjects of the sensors exceed the threshold values and this state lasts for predetermined timer time.

It should be understood that the kinds of the sensors described above are only examples. They are of course not restrictive and other kinds of sensors may be provided when necessary.

The abnormality detection signals are inputted from the plural sensors 5-1 to 5-n described above to the sensor controlling section 3, and a method of inputting these signals may be either a wired method or a so-called wireless method (electromagnetic wave, infrared ray, or the like).

First, in the configuration example shown in FIG. 1, the sensor controlling section 3 first executes a call out to a telephone number, which is pre-stored in the sensor controlling section 3 as a notification destination of an abnormality occurrence, via the interconnecting device 4, when the abnormality detection signal is inputted to the sensor controlling section 3 from either one of the plural sensors 5-1 to 5-n. Next, the sensor controlling section 3 transmits an abnormality notification signal via the interconnecting device 4 when a line with a predetermined telephone is established.

Here, it is preferable that this abnormality notification signal includes information for identifying the aged person (for example, a name, an identification number given in advance, and so on), information on kinds of abnormality (existence and nonexistence of abnormality of gas, temperature, shock, and so on), and so forth.

The sensor controlling section 3 having the functions described above is realizable by a computer such as a PC, a server, or the like and a specialized device.

The interconnecting device 4 is a device for transmitting the abnormality notification signal outputted from the sensor controlling section 3 to the receiving section 2, for example, via a public telephone line 11, and specifically, it is realizable by a hub, a switch, a router, other concentrators, a repeater, a bridge, a gateway device, a PC, a server, a wireless interconnecting device (for example, an interconnecting device of a wireless LAN generally called an access point), and so on.

Meanwhile, the receiving section 2 receives the abnormality notification signal sent from the interconnecting device 4 via the public telephone line 11 and performs processing such as warning, display, and so on.

More specifically, in the configuration example shown in FIG. 1, this receiving section 2 is structured by a personal computer 12 and a warning drive circuit 13 as its main components. This personal computer 12 outputs a response signal to a not-shown exchange when it receives the call out generated in the sensor controlling section 3 in the house of the aged person via the interconnecting device 4 and the public telephone line 11, and thereby it is in a state of being able to receive the abnormality notification signal from the sensor controlling section 3 in the house of the aged person. Then, when receiving the abnormality notification signal, the personal computer 12 displays a name of the aged person in whose house the abnormality occurred, a situation of the abnormality (for example, abnormality detection by the gas sensor, abnormality detection by the temperature sensor, and the like), and so forth on a display device 12a, and furthermore, it causes a speaker 14 to sound with a predetermined warning sound via the warning drive circuit 13, and in addition, causes a warning lamp 15 to light, for example, in red. It is not necessary that the warning display by the display device 12a, the generation of the warning sound by the speaker 14, and the lighting of the warning light 15 are all executed, and it is of course acceptable that only either one of them is executed or a selective combination of some of them is executed.

The receiving section 2 having these functions is preferably installed in plurality in appropriate places of a governmental organization, a non-governmental organization, and so on supporting the lives of aged people as previously explained, namely, for example, a section in charge in a city, town, village office or the like, a firehouse, a police station, a neighboring house and so on.

Next, the whole operation in the above configuration is explained.

To explain, for example, supposing gas leakage occurs, when the gas sensor 5-1 detects gas concentration exceeding a predetermined threshold value in a house of an aged person and this state lasts for a predetermined length of time or longer, an abnormality signal is outputted by the gas sensor 5-1 at an instant the predetermined length of time passes, and the abnormality signal is inputted to the sensor controlling section 3.

The sensor controlling section 3, when the abnormality signal is inputted, outputs a predetermined abnormality notification signal via the interconnecting device 4 to a telephone number pre-stored as a notification destination of an abnormality occurrence. Specifically, the predetermined abnormality notification signal includes information for identifying the aged person (for example, a name, an identification number given in advance, and so on), information on kinds of abnormality (existence and nonexistence of abnormality of gas, temperature, shock and the like), and so forth.

As a result, the abnormality notification signal is inputted to the receiving section 2 via the public telephone line 11. Then, the warning is displayed, the warning sound is generated, and the warning light 15 is lighted to enable the abnormality occurrence in the house of the aged person to be notified and to enable a necessary appropriate countermeasure to be taken.

Incidentally, the operations of the other sensors 5-2 to 5-n are basically the same as that described above, and therefore, explanations of the operations of the sensors 5-2 to 5-n when an abnormality signal is generated are omitted.

The configuration where only one receiving section 2 is provided is shown in FIG. 1, but this configuration is given in order to make the configuration easy to understand and it is preferable that the receiving section 2 is provided in a plurality of places in actual practice. In this case, a plurality of telephone numbers are of course pre-stored in the sensor controlling section 3, and the aforesaid abnormality notification signal is sequentially transmitted to the stored telephone numbers.

Moreover, in the configuration described above, the threshold values and the timer time based on which the abnormality signals are outputted as abnormality of their detection subjects can be set in the plural sensors 5-1 to 5-n. But the configuration in which this function is realized, for example, in the sensor controlling section 3 is also permissible.

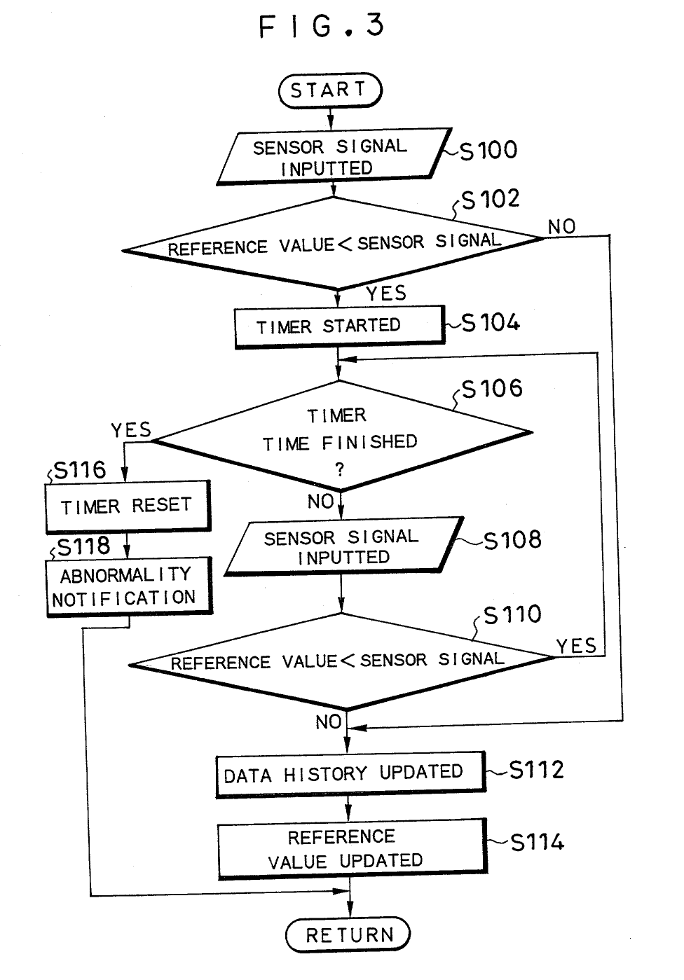

An example of a case where detection signals of the plural sensors 5-1 to 5-n are judged to be abnormal and processing is performed in the sensor controlling section 3 is hereinafter explained with reference to FIG. 3.

First, when the processing is started, a signal of a sensor out of the plural sensors 5-1 to 5-n is read in the sensor controlling section 3 in a predetermined order (refer to Step S100 in FIG. 3).

Next, it is judged whether or not a value of the inputted sensor signal exceeds a reference value set for each sensor (refer to Step S102 in FIG. 3). When this value is judged not to exceed the reference value (in a case of NO), the procedure proceeds to processing in later-described Step S112. Meanwhile, when the value of the sensor signal is judged in Step S102 to exceed the reference value pre-set for this sensor (in a case of YES), a timer is started (refer to Step S104 in FIG. 3). In other words, the lapse of time is measured for a predetermined length of time.

Next, it is judged whether or not the timer time is finished or not (refer to Step S106 in FIG. 3). When it is judged that the timer time is finished (in a case of YES), the procedure proceeds to Step S116 while the procedure proceeds to Step S108 when it is judged that the timer time is not finished (in a case of NO).

In Step S108, the sensor signal is read in the sensor controlling section 3 again since the timer time is not finished, and it is judged whether or not its value exceeds the reference value, similarly to the previous Step S102 (Step S110 in FIG. 3).

Then, when it is judged in Step S110 that the value of the sensor signal exceeds the pre-set reference value (in a case of YES), the procedure returns to the previous Step S106 and the processing starting from Step S106 is repeated again.

Meanwhile, when it is judged in Step S110 or the previous Step S102 that the value of the sensor signal does not exceed the pre-set reference value (in a case of NO), which signifies that abnormality does not exist, a data history is updated with the sensor value at this moment.(refer to Step S112 in FIG. 3). Specifically, in this configuration example, the sensor controlling section 3 is structured to store in predetermined memory areas thereof sensor values which are classified by each of the plural sensors 5-1 to 5-2, and which are obtained every predetermined length of time when the sensor values are not abnormal, as data history information. In Step S112, the sensor value at this moment is newly stored to update the data history information.

Next, the reference value is updated based on the updated data history information (refer to Step S114 in FIG. 3). Therefore, the reference values used in the previous Step 102 and Step S110 are calculated based on the plural sensor values stored in a time sequential order. An arithmetic operation formula for calculating the reference values based on the plural sensor values stored as the data history information should be determined appropriately for each of the sensors 5-1 to 5-n, taking physical nature and the like of detection subjects of the sensors into consideration, and is not necessary to be limited to a specific arithmetic operation formula regardless of the kinds of the sensors 5-1 to 5-n.

Meanwhile, when the procedure proceeds to the processing in Step S116 after the timer time is judged to be finished in the previous Step 106, the timer is reset (refer to Step S116 in FIG. 3) and the abnormality is notified based on the judgment that the abnormality is detected (refer to Step S118 in FIG. 3). Incidentally, specific contents of the abnormality notification are the same as those previously explained in a case of the configuration where the threshold value and the timer time can be set for each of the sensors 5-1 to 5-n, and therefore, detailed explanations thereof are not given here again.

After the processing in Step S118 or Step S114 is finished as described above, the subroutine processing is finished and the procedure once returns to a not-shown main routine, and when no abnormality notification is received, the above-described processing starting from Step S100 is carried out again for the next sensor.

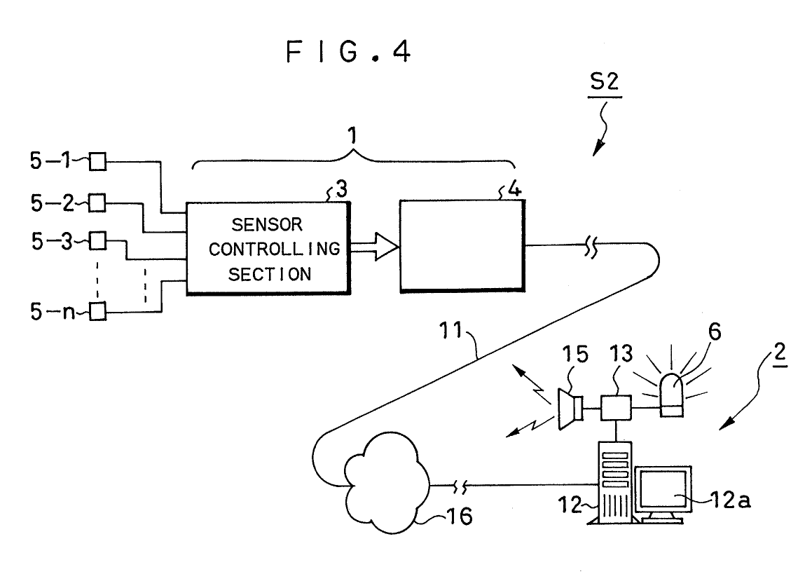

Next a second configuration example of a supporting system for aged people using an interconnecting device in the embodiment of the present invention is explained with reference to FIG. 4. Incidentally, the same reference numerals and symbols are used to designate the same components as those in the configuration example shown in FIG. 1, and therefore, detailed explanations thereof are omitted, and hereinafter, the explanation is given focusing on what is different.

A supporting system S2 for aged people using an interconnecting device in this second configuration example is characterized in that it is structured to send the abnormality notification signal to the receiving section 2 via the Internet 16. Incidentally, basic functions and operations are the same as those in the configuration example which is previously explained with reference to FIG. 1, and therefore, repeated explanations thereof in detail are omitted here.

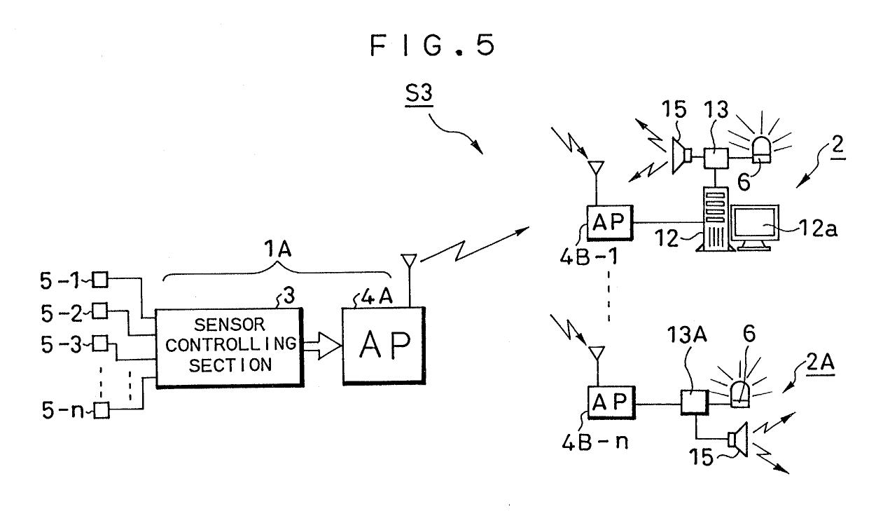

Next, a third configuration example of a supporting system for aged people using an interconnecting device in the embodiment of the present invention is explained with reference to FIG. 5. Incidentally, the same reference numerals and symbols are used to designate the same components as those in the configuration example shown in FIG. 1, and therefore, detailed explanations thereof are omitted, and hereinafter, the explanation is given focusing on what is different.

A supporting system S3 for aged people using an interconnecting device in this third configuration example is characterized in that it is structured to use a wireless interconnecting device.

Specifically, in this configuration example, both of the sensor controlling section 3 and a plurality of receiving sections 2 and 2A are connected to wireless interconnecting devices 4A and 4B-1 to 4B-n respectively. To be specific, wireless interconnecting devices based on the International Standard IEEE802.11 and 802.11b defined by IEEE (Institute of Electrical and Electronics Engineers) are appropriate for these wireless interconnecting devices 4A and 4B-1 to 4B-n. These wireless interconnecting devices are generally called wireless access points or, simply, access points.

In the configuration described above, it is preferable that the wireless interconnecting devices 4A and 4B-1 to 4B-n are installed in a manner that communication ranges of adjoining devices overlap in part one another. This is because such configuration ensures that the receiving sections 2 and 2A receive the abnormality notification since packets are transferred in sequence by a so-called packet transfer function which these wireless interconnecting devices 4A and 4B-1 to 4B-n have, even when either one of the wireless interconnecting devices 4B-1 to 4B-n on receiving section 2 and 2A sides is not included directly in the communication range of the wireless interconnecting device 4A on an aged person's side.

As described above, in this configuration example, a so-called wireless LAN (Local Area Network) is formed by the wireless interconnecting devices 4A and 4B-1 to 4B-n.

Furthermore, in this configuration example, the receiving section 2A is structured by a warning drive circuit 13A as its main component without using a personal computer.

In this case, the warning drive circuit 13A is provided with a function executed for the receiving signal by the personal computer 12 as previously explained in the configuration shown in FIG. 1. In other words, the personal computer 12 is not necessarily an indispensable element in structuring the receiving section 2, and any device capable of achieving the function of the receiving section 2 as previously described is sufficient.

Incidentally, the above-mentioned warning drive circuit 13A may of course be alternatively used to substitute for the personal computer 12 in the previously explained configuration shown in FIG. 1 or FIG. 4.

Moreover, in any of the configurations in FIG. 1, FIG. 4, and FIG. 5, the sensor controlling section 3 is a separate structure from the interconnecting device 4 and the wireless interconnecting devices 4A and 4B-1 to 4B-n, but a specialized board for the sensor controlling section may be mounted inside the interconnecting device 4 or the wireless interconnecting devices 4A and 4B-1 to 4B-n so that it is integrally structured with the interconnecting device 4 or the wireless interconnecting devices 4A and 4B-1 to 4B-n.

As described hitherto, according to the present invention, the structure to enable an abnormality occurrence in a house of an aged person to be detected and a detection signal of the abnormality to be transmitted to the outside, especially, to a predetermined place using the interconnecting. device brings about the effect that abnormality of the aged person can be found quickly and surely while securing privacy of the aged person and reducing necessary manpower to the minimum and an appropriate countermeasure can be taken.

Moreover, since an appropriate countermeasure can be taken quickly against an abnormality occurrence in the house of the aged person, the effect is brought about that the aged person can have a deep sense of relief and smooth support for the life of the aged person can be realized.

What is claimed is:

1. A supporting system for aged people using an interconnecting device, comprising:
a plurality of sensors for detecting abnormality inside a house of an aged person;
a sensor controlling section for outputting an abnormality notification signal based on output signals of said plural sensors;
an interconnecting device for interconnecting an output signal of said sensor controlling section to a receiving section; and
the receiving section for performing warning processing when it receives the abnormality notification signal from said sensor controlling section.

2. A supporting system for aged people using an interconnecting device according to claim 1, wherein said plural sensors include at least:
a gas sensor which is disposed near a gas appliance, for detecting gas leakage from the gas appliance;
a temperature sensor which is disposed at a plurality of appropriate places in a room, for detecting abnormal increase in temperature inside the room; and
a shock sensor which is disposed at a plurality of appropriate places inside the room, for detecting that the aged person falls down in the room.

3. A supporting system for aged people using an interconnecting device according to claim 2,
wherein said plural sensors include an in/out detecting sensor for detecting that the aged person gets into and out of a washroom.

4. A supporting system for aged people using an interconnecting device according to claim 3,
wherein said plural sensors include an in/out detecting sensor for detecting that the aged person gets in and out of a bathroom.

5. A supporting system for aged people using an interconnecting device according to claim 4,
wherein the temperature sensor is disposed on a floor, a ceiling and a wall respectively inside the house.

6. A supporting system for aged people using an interconnecting device according to claim 5,
wherein said plural sensors are structured to be able to set prescribed threshold values respectively in advance.

7. A supporting system for aged people using an interconnecting device according to claim 6,
wherein each of said plural sensors outputs an abnormality signal when a value of a detection subject continues to be in a state of exceeding the threshold value for a predetermined length of time, judging the state as abnormal, and is structured to be able to freely set the predetermined length of time as timer time.

8. A supporting system for aged people using an interconnecting device according to claim 1,
wherein said sensor controlling section outputs the abnormality notification signal to a pre-stored notification destination via said interconnecting device when either one of said plural sensors outputs the abnormality signal.

9. A supporting system for aged people using an interconnecting device according to claim 7,
wherein said sensor controlling section outputs the abnormality notification signal to a pre-stored notification destination via said interconnecting device when either one of said plural sensors outputs the abnormality signal.

10. A supporting system for aged people using an interconnecting device according to claim 5,
wherein said sensor controlling section outputs the abnormality notification signal to a pre-stored notification destination via said interconnecting device when the output signal of either one of said plural sensors exceeds a threshold value set for each of the plural sensors in advance for a predetermined length of time.

11. A supporting system for aged people using an interconnecting device according to claim 8,
wherein said interconnecting device is structured to interconnect the output signal of said sensor controlling section to said receiving section via a public telephone line.

12. A supporting system for aged people using an interconnecting device according to claim 9,
wherein said interconnecting device is structured to interconnect the output signal of said sensor controlling section to said receiving section via a public telephone line.

13. A supporting system for aged people using an interconnecting device according to claim 10,
wherein said interconnecting device is structured to interconnect the output signal of said sensor controlling section to said receiving section via a public telephone line.

14. A supporting system for aged people using an interconnecting device according to claim 11,
wherein said interconnecting device is realized by a hub, a switch, or a router.

15. A supporting system for aged people using an interconnecting device according to claim 14,
wherein said interconnecting device is structured to accommodate said sensor controlling section.

16. A supporting device for aged people,
wherein abnormality inside a house of an aged person is detected and an abnormality notification signal is outputted to a predetermined external place.

17. A supporting device for aged people according to claim 16, comprising:
a plurality of sensors for detecting the abnormality inside the house of the aged person;
a sensor controlling section for outputting an abnormality notification signal based on output signals of said plural sensors; and
an interconnecting device for interconnecting an output signal of said sensor controlling section to the predetermined external place.

18. A supporting device for aged people according to claim 17,
wherein said plural sensors includes at least:
a gas sensor which is disposed near a gas appliance, for detecting gas leakage from the gas appliance;
a temperature sensor which is disposed at a plurality of appropriate places in a room, for detecting abnormal increase in temperature inside the room; and
a shock sensor which is disposed at a plurality of appropriate places inside the room, for detecting that the aged person falls down in the room.

19. A supporting device for aged people according to claim 18,
wherein said plural sensors include an in/out detecting sensor for detecting that the aged person gets into and out of a washroom.

20. A supporting device for aged people according to claim 19,
wherein said plural sensors include an in/out detecting sensor for detecting that the aged person gets in and out of a bathroom.

21. A supporting device for aged people according to claim 20,
wherein the temperature sensor is disposed on a floor, a ceiling and a wall respectively inside the house.

22. A supporting device for aged people according to claim 21,
wherein said plural sensors are structured to be able to set prescribed threshold values respectively in advance.

23. A supporting device for aged people according to claim 22,
wherein each of said plural sensors outputs an abnormality signal when a value of a detection subject continues to be in a state of exceeding the threshold value for a predetermined length of time, judging the state as abnormal, and is structured to be able to freely set the predetermined length of time as timer time.

24. A supporting device for aged people according to claim 17,
wherein said sensor controlling section outputs the abnormality notification signal to a pre-stored notification destination via said interconnecting device when either one of said plural sensors outputs the abnormality signal.

25. A supporting device for aged people according to claim 23,
wherein said sensor controlling section outputs the abnormality notification signal to a pre-stored notification destination via said interconnecting device when either one of said plural sensors outputs the abnormality signal.

26. A supporting device for aged people according to claim 21,
wherein said sensor controlling section outputs the abnormality notification signal to a pre-stored notification destination via said interconnecting device when the output signal of either one of said plural sensors exceeds a threshold value set for each of the plural sensors in advance for a predetermined length of time.

27. A supporting device for aged people according to claim 24,
wherein said interconnecting device is structured to interconnect the output signal of said sensor controlling section to the predetermined external place via a public telephone line.

28. A supporting device for aged people according to claim 25,
wherein said interconnecting device is structured to interconnect the output signal of said sensor controlling section to the predetermined external place via a public telephone line.

29. A supporting device for aged people according to claim 26,
wherein said interconnecting device is structured to interconnect the output signal of said sensor controlling section to the predetermined external place via a public telephone line.

30. A supporting device for aged people according to claim 27,
wherein said interconnecting device is realized by a hub, a switch, or a router.

31. A supporting device for aged people according to claim 30,
wherein said interconnecting device is structured to accommodate said sensor controlling section.
